(19) United States
(12) Patent Application Publication
(10) Pub. No.: US 2014/0200061 A1
(43) Pub. Date: Jul. 17, 2014

(54) INFORMATION PROCESSING DEVICE, AND NON-TRANSITORY COMPUTER-READABLE STORAGE MEDIUM STORING GAME PROGRAM

(71) Applicant: DeNA Co., Ltd., Tokyo (JP)

(72) Inventors: Tatsuya ISA, Tokyo (JP); Jumpei Ueno, Tokyo (JP)

(73) Assignee: DeNA Co., Ltd., Tokyo (JP)

(21) Appl. No.: 14/103,547

(22) Filed: Dec. 11, 2013

(30) Foreign Application Priority Data
Jan. 16, 2013 (JP) 2013-005297

(51) Int. Cl. A63F 13/00

(52) U.S. Cl. CPC A63F 13/00
USPC 463/9

(57) ABSTRACT

An information processing device conducts a battle game played by a player by using a battle deck composed of game contents, including: a deck forming unit configured to form the battle deck to be used for a battle by the player; a parameter determining unit configured to determine a deck parameter value; a storage unit configured to store a parameter change condition; a determination unit configured to determine whether or not the parameter change condition is satisfied after the deck parameter value is determined by the parameter determining unit; a parameter changing unit configured to change the deck parameter value; a battle processing unit configured to: determine an outcome of a battle game by using the deck parameter value resulting from the change by the parameter changing unit, and determine an outcome of a battle game; and a screen data generation unit configured to generate data of a game screen.

### BACKGROUND OF THE INVENTION

1. Field of the Invention

The present invention relates to an information processing device and a game program.

2. Description of the Related Art

Game systems for conducting battle games played by players using game contents such as character cards have been known, and the game contents have parameters such as attack point and defense point set therefor (for example, Japanese Patent Application Laid-Open No. 2005-168744).

### SUMMARY OF THE INVENTION

An outcome of such a battle game is not only determined on the basis of comparison of parameters set for the game contents but also determined randomly by calculating the win/loss result by using a random number. Thus, it may be difficult for a player to figure out why the player won (or lost) when the determined win/loss result is presented.

The present invention has been made in view of the foregoing, and an object is to give a feeling of accepting a win/loss result of a battle game.

A principal invention of the present invention to solve the aforementioned problems is an information providing device that conducts a battle game played by a player by using a battle deck composed of a plurality of game contents, the information processing device including:

a deck forming unit configured to form the battle deck to be used for a battle by the player;

a parameter determining unit configured to determine a deck parameter value set for the battle deck formed by the deck forming unit on the basis of game content parameter values set for the game contents included in the battle deck;

a storage unit configured to store a parameter change condition that is a condition for changing the deck parameter value determined by the parameter determining unit and a predetermined value by which the deck parameter value determined by the parameter determining unit is changed in association with each other;

a determination unit configured to determine whether or not the parameter change condition is satisfied after the deck parameter value is determined by the parameter determining unit;

a parameter changing unit configured to change the deck parameter value determined by the parameter determining unit by using a predetermined value corresponding to the parameter change condition when the parameter change condition is determined to be satisfied by the determination unit;

a battle processing unit configured to:

determine an outcome of a battle game by using the deck parameter value resulting from the change by the parameter changing unit when the parameter change condition is determined to be satisfied by the determination unit, and

determine an outcome of a battle game by using the deck parameter value determined by the parameter determining unit when the parameter change condition is determined not to be satisfied by the determination unit; and

a screen data generation unit configured to generate data of a game screen on which parameter information indicating the deck parameter value resulting from the change by the parameter changing unit or the deck parameter value determined by the parameter determining unit after an outcome is determined by the battle processing unit.

Other characteristics of the present invention will become clear from the description of the present specification and the appended drawings.

### Advantageous Effect of the Invention

According to the present invention, a feeling of accepting a win/loss result of a battle game can be given to a player.

### BRIEF DESCRIPTION OF THE DRAWINGS

FIG. 1 is a diagram illustrating an overall configuration example of a game system;

FIG. 2 is a block diagram illustrating a functional configuration of a server device;

FIG. 3 is a block diagram illustrating a functional configuration of a player terminal;

FIG. 4 is a table illustrating an example of a data structure of card information;

FIG. 5 is a table illustrating an example of a data structure of player information;

FIG. 6 is a table illustrating an example of a data structure of possessed card information;

FIG. 7 is a table illustrating an example of a data structure of first deck information;

FIG. 8 is a table illustrating an example of a data structure of second deck information;

FIG. 9 is a table explaining card hand information;

FIG. 10 is a table explaining skill information;

FIG. 11 is a flowchart explaining an example of operation (first half) of the game system;

FIG. 12 is a flowchart explaining an example of operation (second half) of the game system;

FIG. 13 is a diagram explaining screen transition (first half) in a battle game;

FIG. 14 is a diagram explaining screen transition (second half) in the battle game;

FIG. 15 is a flowchart explaining a deck parameter calculation process (multiplication); and

FIG. 16 is a flowchart explaining a deck parameter calculation process (addition).

### DETAILED DESCRIPTION OF THE INVENTION

At least the following matters will become clear according to the description of the present specification and the appended drawings:

An information providing device that conducts a battle game played by a player by using a battle deck composed of a plurality of game contents, the information processing device including:

a deck forming unit configured to form the battle deck to be used for a battle by the player;

a parameter determining unit configured to determine a deck parameter value set for the battle deck formed by the deck forming unit on the basis of game content parameter values set for the game contents included in the battle deck;

a storage unit configured to store a parameter change condition that is a condition for changing the deck parameter value determined by the parameter determining unit and a predetermined value by which the deck parameter value determined by the parameter determining unit is changed in association with each other;

a determination unit configured to determine whether or not the parameter change condition is satisfied after the deck parameter value is determined by the parameter determining unit;

a parameter changing unit configured to change the deck parameter value determined by the parameter determining unit by using a predetermined value corresponding to the parameter change condition when the parameter change condition is determined to be satisfied by the determination unit;

a battle processing unit configured to:

determine an outcome of a battle game by using the deck parameter value resulting from the change by the parameter changing unit when the parameter change condition is determined to be satisfied by the determination unit, and

determine an outcome of a battle game by using the deck parameter value determined by the parameter determining unit when the parameter change condition is determined not to be satisfied by the determination unit; and

a screen data generation unit configured to generate data of a game screen on which parameter information indicating the deck parameter value resulting from the change by the parameter changing unit or the deck parameter value determined by the parameter determining unit after an outcome is determined by the battle processing unit.

According to such an information processing device, the parameter information indicating the deck parameter values is presented to the player, which can give a feeling of accepting the win/loss result of the battle game to the player.

Furthermore, in the information processing device,

the storage unit may store a plurality of game contents possessed by the player and store preset hands,

the deck forming unit may include a first deck forming unit configured to select game contents from game contents possessed by the player, the number of selected game contents being smaller than the number of game contents possessed by the player, to form a preliminary deck composed of game contents used for forming a preset hand, and a second deck forming unit configured to randomly select game contents from the game contents included in the preliminary deck, the number of selected game contents being smaller than the number of game contents included in the preliminary deck, to form a battle deck, and

the parameter change condition may be that a preset hand is made by the battle deck.

According to such an information processing device, the number of game contents to be used for forming a preset hand can be made smaller than the number of game contents possessed by the player, which allows a battle deck to easily make a preset hand.

Furthermore, in the information processing device, the first deck forming unit may select game contents of the preliminary deck from the game contents possessed by the player in response to operation input by the player.

According to such an information processing device, game contents to be used for forming a preset hand can be selected by the player, which can give a greater feeling of acceptance to the player.

In the information processing device, the first deck forming unit may select a plurality of game contents of the preliminary deck from the game contents possessed by the player on the basis of game contents parameter values set for the game contents.

According to such an information processing device, a preliminary deck can automatically be formed without operation by the player.

Furthermore, in the information processing device,

the storage unit may store a game content for which any of multiple kinds of first attributes is set and a player possessing the game content in association with each other, and

the first deck forming unit may select a plurality of game contents from game contents possessed by the player for each of the first attributes and assign any of multiple kinds of second attributes to each of the selected game contents to form the preliminary deck composed of game contents each having the first attribute and the second attribute.

According to such an information processing device, multiple kinds of attributes area set for game contents included in the preliminary deck, which can increase the kinds of the preset hands.

### Embodiment

### <<Configuration of Game System 1>>

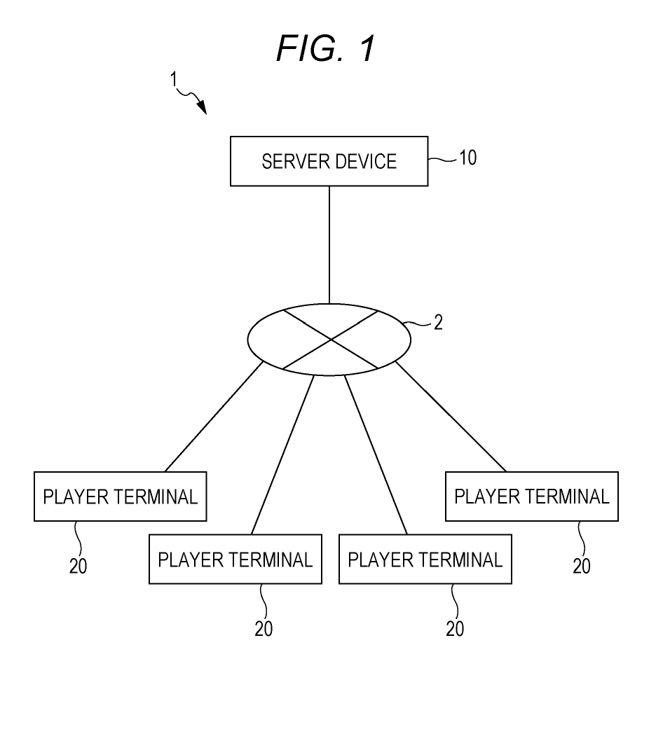

FIG. 1 is a diagram illustrating an example of an overall configuration of a game system 1 according to the present embodiment. The game system 1 provides players with various services related to games through a network 2 (for example, the Internet or the like), and includes a server device 10 and a plurality of player terminals 20.

### <<Configuration of Server Device 10>>

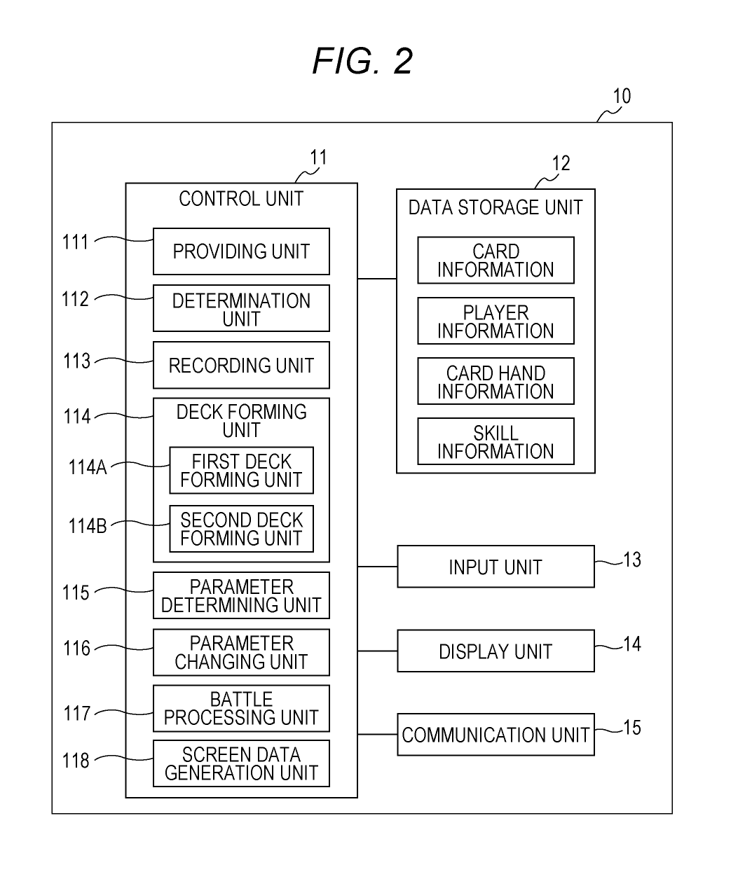

FIG. 2 is a block diagram illustrating a functional configuration of the server device 10 according to the present embodiment. The server device 10 is an information processing device (for example, a workstation, a personal computer, or the like) used when a system administrator or the like manages the game service. The server device 10 can distribute game programs operable on a player terminal 20, and web pages (such as a game screens) made in a markup language (such as HTML) according to the specification of the player terminal 20 upon receiving various commands (requests) from the player terminal 20. The server device 10 includes a control unit 11, a data storage unit 12, an input unit 13, a display unit 14, and a communication unit 15.

The control unit 11 is configured to pass data among the units and control the entire server device 10, and is realized by a central processing unit (CPU) executing a program stored in a predetermined memory. The control unit 11 of the present embodiment includes a providing unit 111, a determination unit 112, a recording unit 113, a deck forming unit 114, a parameter determining unit 115, a parameter changing unit 116, a battle processing unit 117, and a screen data generation unit 118.

The providing unit 111 includes a function to execute a process of providing a player with a game content to be used in a game. A game content refers to a game card, a figure or the like associated with a character or the like, or an item or the like such as a tool or an ability that can be used in a game. The providing unit 111 of the present embodiment provides a game card as the game content to be used in a virtual space in a game.

The determination unit 112 has a function to execute various determination processes such as a process of determining whether or not a parameter change condition, which will be described later, is satisfied.

The recording unit 113 is connected to the data storage unit 12 via a bus, and has a function to execute a recording process of recording data into the data storage unit 12 in response to a command from the control unit 11.

The deck forming unit 114 has a function to form a deck composed of multiple game cards. A deck refers to a card group of multiple cards put into a set. The deck forming unit 114 includes a first deck forming unit 114A and a second deck forming unit 114B.

The first deck forming unit 114A has a function to form a first deck composed of multiple game cards selected from game cards possessed by a player. In the present embodiment, a preliminary deck that is an example of the first deck is formed. A preliminary deck is a deck composed of game cards that are candidates to be selected for forming a battle deck and that are to be used for forming a predetermined hand, which will be described later.

The second deck forming unit 114B has a function to form a second deck composed of multiple game cards selected from the game cards included in the first deck. In the present embodiment, a battle deck that is an example of the second deck is formed. As battle deck is a deck used for a battle and composed of a smaller number of game cards than the number of game cards included in the preliminary deck.

The parameter determining unit 115 has a function to determine the value of a deck parameter set for a deck on the basis of card parameters set for the respective game cards composing the deck.

The parameter changing unit 116 has a function to change the value of the deck parameter determined by the parameter determining unit 115 when the parameter change condition, which will be described later, is satisfied.

The battle processing unit 117 has a function to execute a battle game process of making a battle deck of a player compete against a battle deck of an opponent. The battle processing unit 117 of the present embodiment determines the outcome of a battle game by using the deck parameter value resulting from the change by the parameter changing unit 116 when the parameter change condition to be described later is satisfied, and determines the outcome of a battle game by using the deck parameter value resulting from the determination by the parameter determining unit 115 when the parameter change condition to be described later is not satisfied.

The screen data generation unit 118 has a function to execute a process of generating screen data for displaying an operation screen and a game screen for allowing the player to play games on the player terminal 20. The screen data generation unit 118 of the present embodiment generates HTML data as the screen data for the game screen.

The data storage unit 12 includes a read only memory (ROM) that is a read only storage area in which a system program is stored, and a random access memory (RAM) that is a rewritable storage area used as a work area for arithmetic processing by the control unit 11. The data storage unit 12 is, for example, realized by a non-volatile storage device, such as flash memory or a hard disk. The data storage unit 12 of the present embodiment stores at least card information that is information on game cards that are an example of the game contents, player information on the player, card hand information, and skill information. Details of the information will be described later.

The input unit 13 is used by the system administrator or the like for inputting various data (for example, the card information or the like), and is realized, for example, by a keyboard, a mouse, and the like.

The display unit 14 is used for displaying an operation screen for the system administrator on the basis of a command from the control unit 11, and is realized, for example, by a liquid crystal display (LCD) or the like.

The communication unit 15 is used for performing communication with the player terminals 20, and has a function as a reception unit to receive various data and signals transmitted from the player terminals 20, and a function as a transmission unit to transmit various data and signals to the player terminals 20 according to commands from the control unit 11. The communication unit 15 is realized, for example, by a network interface card (NIC), or the like.

### <<Configuration of Player Terminal 20>>

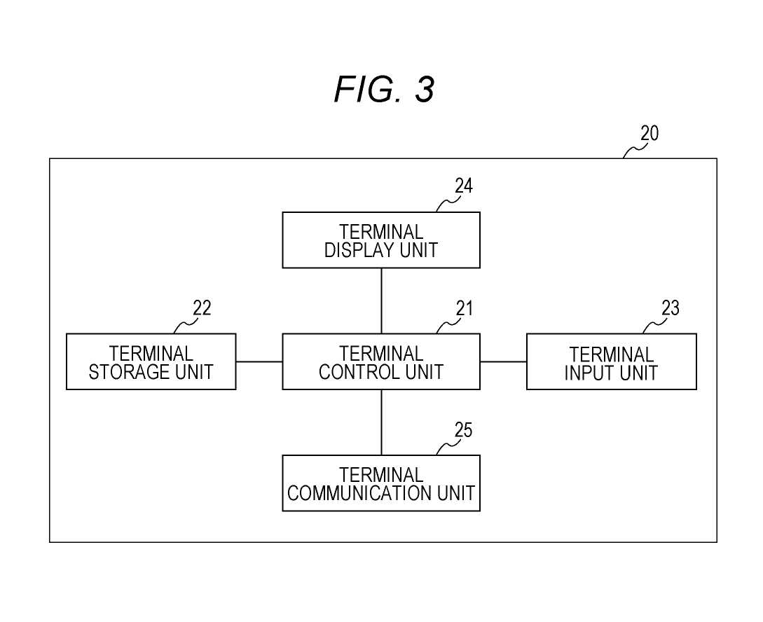

FIG. 3 is a block diagram illustrating a functional configuration of a player terminal 20. The player terminal 20 of the present embodiment is an information processing device (for example, a mobile phone terminal, a smart phone, or the like) used by the player when playing a game, and can request the server device 10 to deliver various types of information (a game program, a web page, or the like) related to the game. The player terminal 20 has a web browser function for allowing the player to browse a web page, and thus can display a web page (a game screen, or the like) delivered from the server device 10. The player terminal 20 includes a terminal control unit 21, a terminal storage unit 22, a terminal input unit 23, a terminal display unit 24, and a terminal communication unit 25.

The terminal control unit 21 is configured to pass data among the units and control the entire player terminal 20, and is realized by a central processing unit (CPU) executing a program stored in a predetermined memory. Note that the terminal control unit 21 of the present embodiment also functions as a screen display control unit that controls a display form of a game screen displayed on the terminal display unit 24. The terminal storage unit 22 is connected to the terminal control unit 21 through a bus, and performs processing of referring to, reading out, and rewriting stored data according to a command from the terminal control unit 21. The terminal storage unit 22 is realized, for example, by flash memory, a hard disk, or the like. The terminal input unit 23 is used for performing various operations (a game operation, and the like) by the player, and is realized, for example, by an operation button, a touch panel, and the like. The terminal display unit 24 is used for displaying a game screen by a command from the terminal control unit 21, and is realized, for example, by a liquid crystal display (LCD) and the like. The terminal communication unit 25 functions as a transmission/reception unit for performing transmission/reception of various types of information to/from the server device 10 through the network 2, and is realized, for example, by a network interface card (NIC), or the like.

### <<Data Structure>>

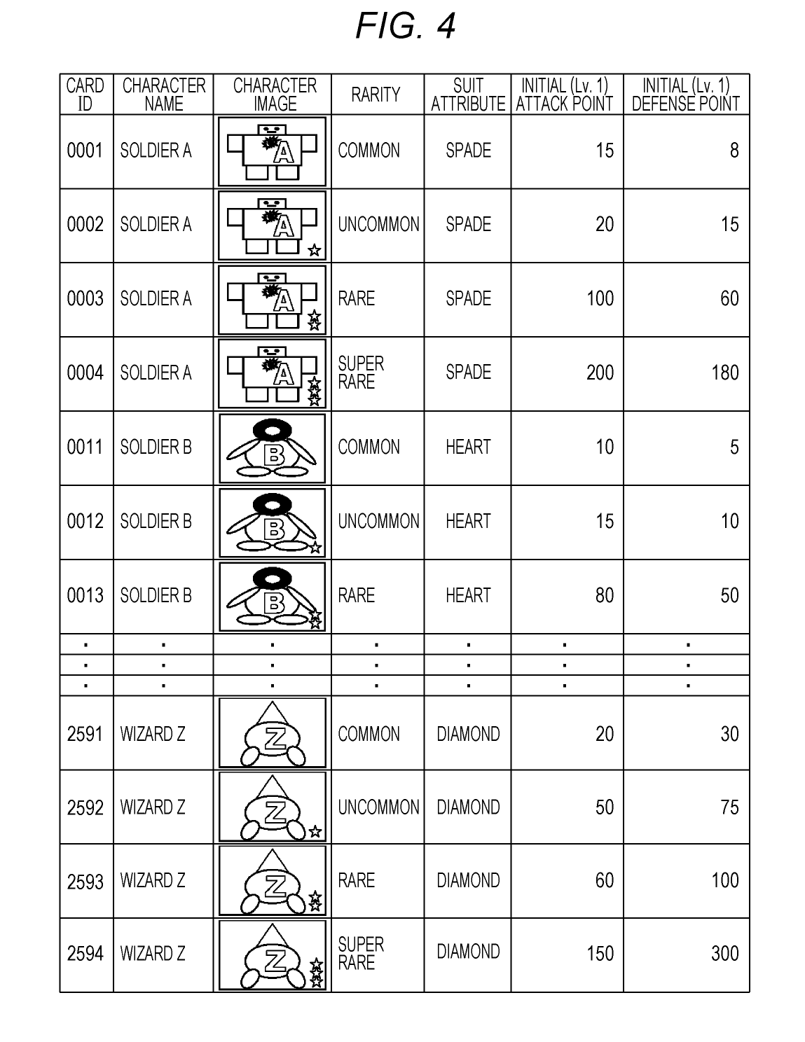

FIG. 4 is a diagram illustrating an example of a data structure of the card information stored in the storage unit 12 of the server device 10. The card information contains items (fields) such as a card ID, a character name, a character image, rarity, a suit attribute that is an example of the first attribute, initial attack point, initial defense point, and initial hit point. The card ID is identification information for identifying a game card that is an example of the game content. The character name is information indicating a display name of a character associated with a game card. The character image is image data of a character. The rarity is information indicating the degree of rarity classified into a plurality of classes according to a rarity value of a game card. In the present embodiment, four classes of rarity (“common”→“uncommon”→“rare”→“super rare”) are set for game cards. The suit attribute is attribute information indicating a kind of suits assigned in advance to a game card. In the present embodiment, any one of four suits (spade, heart, club, and diamond) is set for a game card. The initial attack point, the initial defense point, and the initial hit point of a character are parameters indicating ability values initially set for the character.

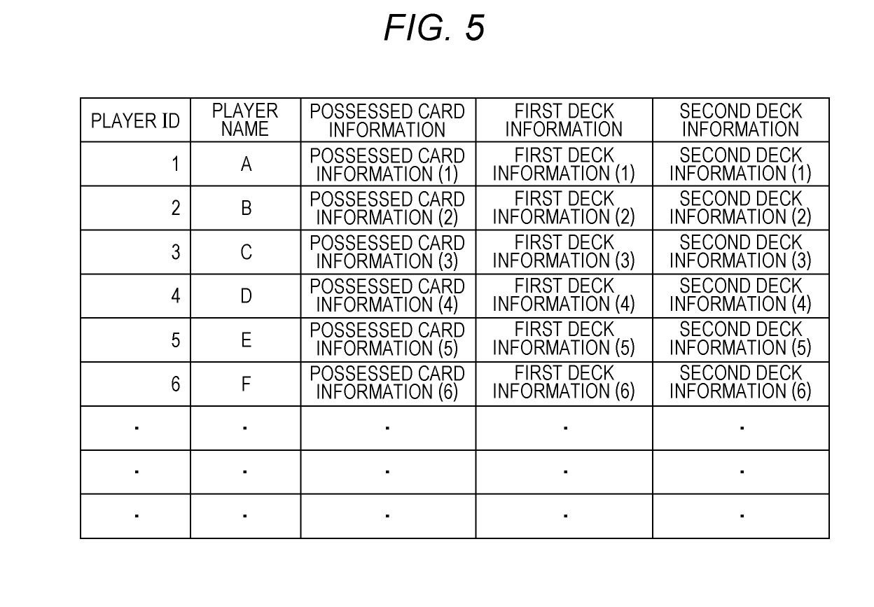

FIG. 5 is a diagram illustrating an example of a data structure of the player information stored in the storage unit 12 of the server device 10. The player information contains items such as a player ID, a player name, possessed card information, first deck information, second deck information, and the like. The player ID is identification information for identifying a player. The player name is information indicating a display name of a player. The possessed card information is information indicating game cards (hereinafter also referred to as possessed cards) possessed by a player. The first deck information is information on a first deck formed by the first deck forming unit 114A. The second deck information is information on a second deck formed by the second deck forming unit 114B.

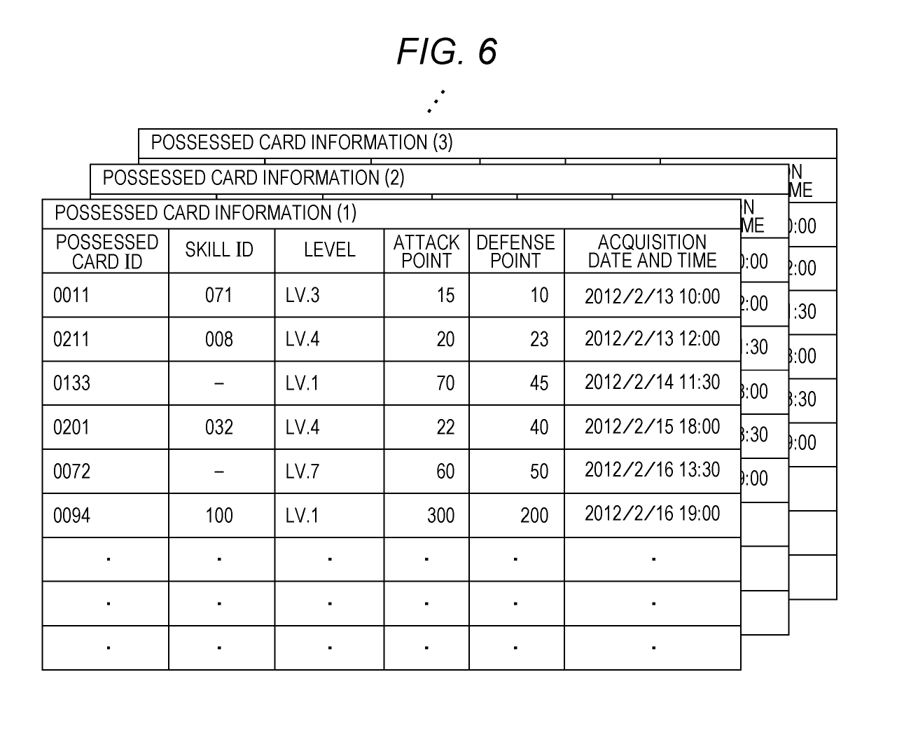

FIG. 6 is a table illustrating an example of a data structure of the possessed card information. The possessed card information contains items such as a possessed card ID, a skill ID, the level of a possessed card, attack point, defense point, and acquisition date and time. The possessed card ID is identification information for identifying a possessed card. The skill ID is identification information for identifying a skill associated with a possessed card. The possessed card level, the attack point, and the defense point are parameters (card parameters) indicating ability values set for a character associated with a possessed card. These parameters are updated according to a result of a battle game or the like. The acquisition date and time is information indicating the date and time at which a player acquired a possessed card.

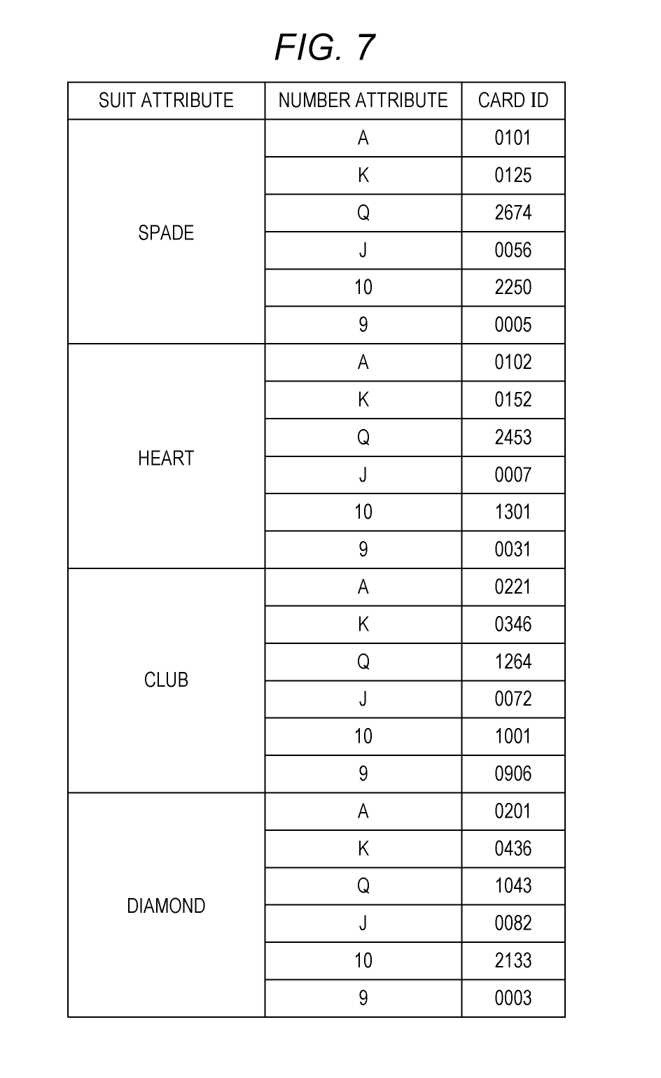

FIG. 7 is a table illustrating an example of a data structure of the first deck information. The first deck information is information defining a preliminary deck that is an example of the first deck, which is information of a predetermined number of game cards put into a set. The first deck information contains items such as a suit attribute that is an example of the first attribute, a number attribute that is an example of the second attribute, and card IDs for identifying game cards included in a preliminary deck. The preliminary deck of the present embodiment includes 24 kinds of game cards in combination of four suit attributes, which are spade, heart, club and diamond, and six number attributes, which are 9, 10, 11 (jack: J), 12 (queen: Q), 13 (king: K), and 1 (ace: A), put into a set.

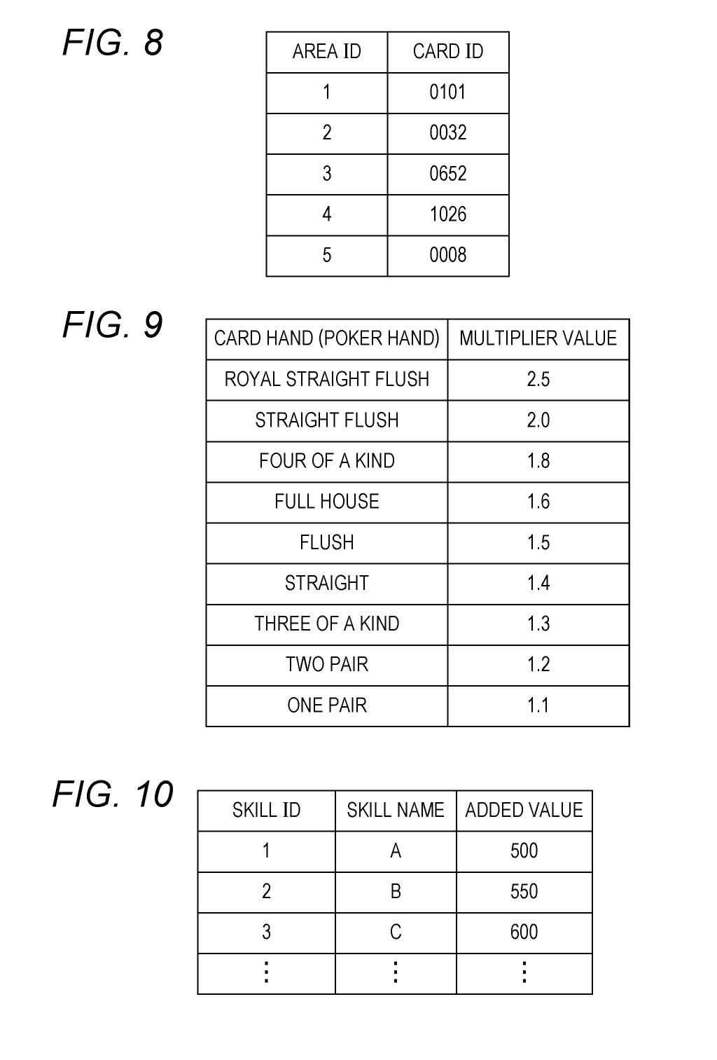

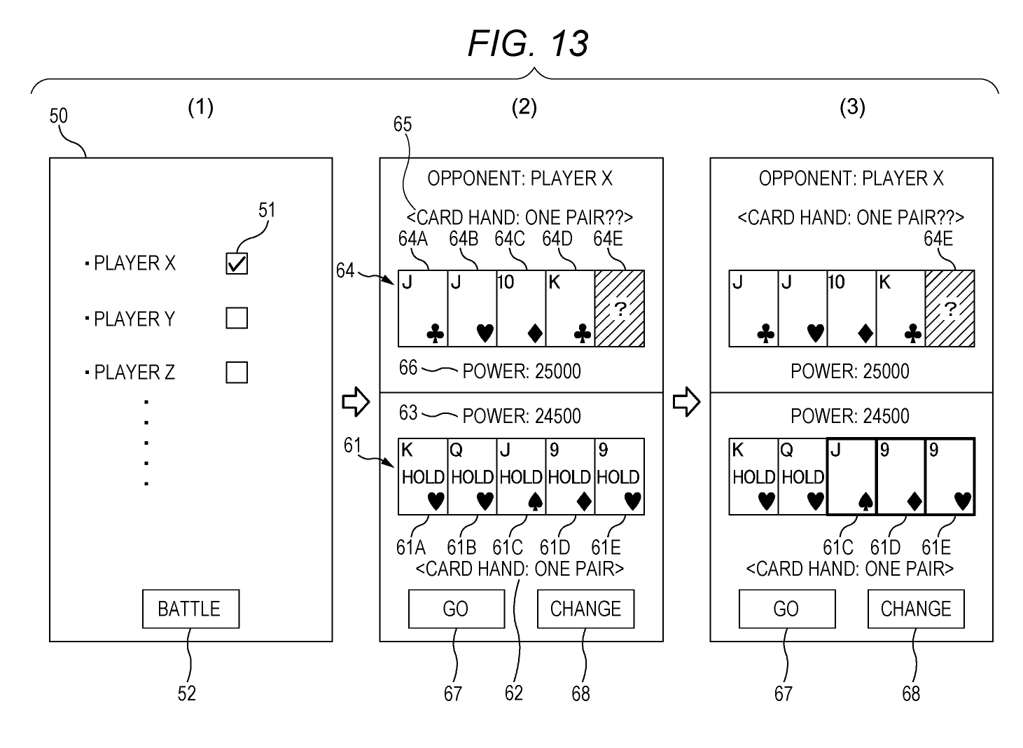

FIG. 8 is a table illustrating an example of a data structure of the second deck information. The second deck information is information defining a battle deck that is an example of the second deck, which is information of a predetermined number of game cards put into a set. The second deck information contains items of an area ID and a card ID. The area ID is identification information for identifying a unit area in a card placement area. The card placement area of the present embodiment is divided into five unit areas (see FIG. 13 (2)), and five area IDs are thus set. The card ID is identification information for identifying each of game cards included in a battle deck. The battle deck of the present embodiment includes five game cards to be placed on respective unit areas and put into a set.

FIG. 9 is a diagram illustrating an example of a data structure of the card hand information stored in the storage unit 12 of the server device 10. The card hand information is information associating a multiplier value (predetermined value) with each card hand (predetermined hand). The card hand is information indicating a preset combination of game cards. The multiplier value is a value (a value specifying the multiplying factor) by which the deck parameter value determined by the parameter determining unit 115 is multiplied. In the data structure of the present embodiment, a card hand that is more difficult to make in a normal poker game has a larger multiplier value.

FIG. 10 is a diagram explaining the skill information stored in the storage unit 12 of the server device 10. The skill information is information associating an added value (predetermined value) with each skill type. The skill information contains items of a skill ID, a skill name and the added value. The skill information is information for identifying a skill that is a special skill of a battle deck (or a character associated with a game card). The skill name is information indicating a display name of a skill. The added value is a positive or negative value added to the deck parameter value determined by the parameter determining unit 115.

### <<Game Outline>>

Here, an outline of a game provided by the game system 1 of the present embodiment will be described. The game system 1 provides various games conducted by using game cards (virtual cards used in a virtual space of a game).

In the game system 1 of the present embodiment, a player can possess a plurality of game cards each being associated with a game character. The player can play a battle game by using a battle deck composed of the game cards that the player possesses.

In the battle game of the present embodiment, a poker game using the battle deck is conducted. The poker game of the present embodiment is conducted by using 24 game cards selected from the game cards that the player possesses unlike the poker game conducted by using 52 cards such as the actual playing cards. Specifically, 24 game cards in combination of four suit attributes (spade, heart, club, and diamond) and six number attributes (1, 9 to 13) are used instead of 52 playing cards in combination of four suit attributes (spade, heart, club, and diamond) and 13 number attributes (1 to 13).

Upon start of the battle game, 24 game cards are selected from the game cards that the player possesses to form a preliminary deck that is a talon for the player. Five cards are then randomly selected from the preliminary deck composed of 24 game cards to form a battle deck composed of five game cards that constitute a hand. As a result of limiting the number of game cards included in a preliminary deck to 24 (24 kinds) in this manner, possible kinds of hands (also referred to as poker hands) of the poker game are also limited and the kinds of game cards that are candidates for selection in formation of a battle deck are also limited. A battle deck can thus easily make a poker hand.

The player makes his/her battle deck compete against a battle deck of an opponent, and if the player's battle deck composed of five game cards can make a preset poker hand, the player can gain a reward depending on the kind of the poker hand. In addition, if the player can exercise a skill for his/her battle deck, the player can gain a reward depending on the skill. The reward thus gained is reflected in the parameter value of the battle deck and the outcome of the battle game is determined by using the parameter value. Upon determination of the outcome of the battle game in this manner, parameter information indicating the parameter values of the battle decks at the outcome determination as well as the win/loss result are displayed to the player. Thus, player can know why the player won (or lost) and can thus accept the win/loss result of the battle game.

### <<Operation of Game System 1>>

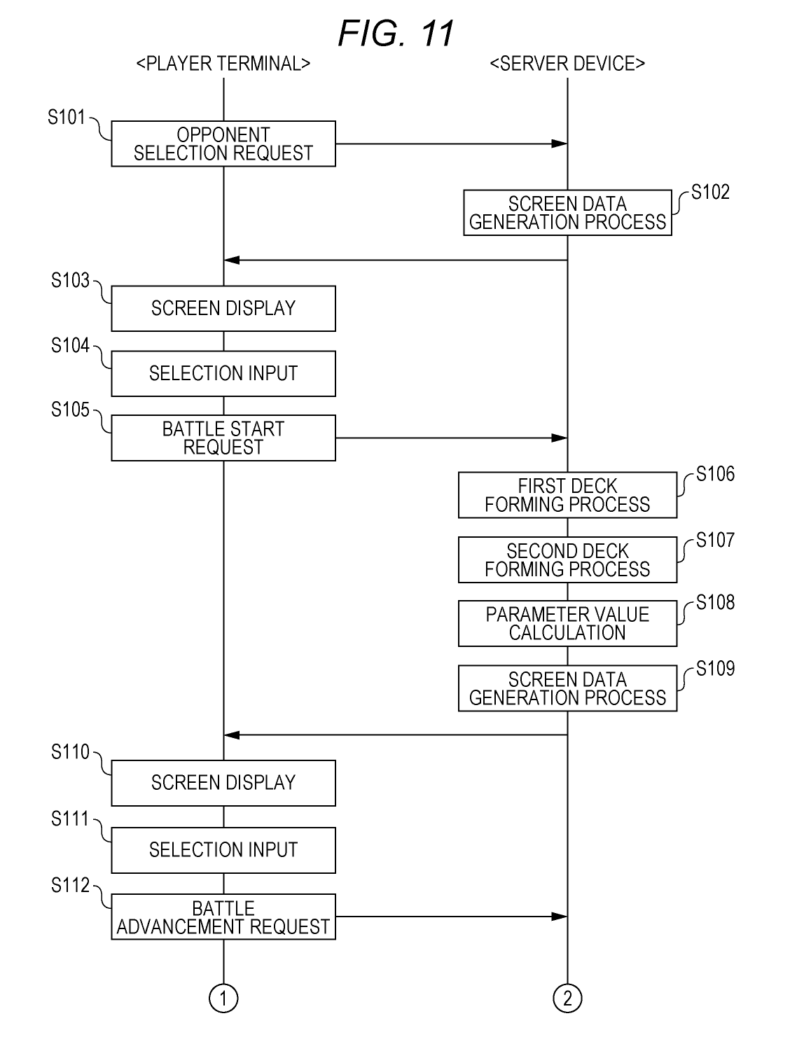

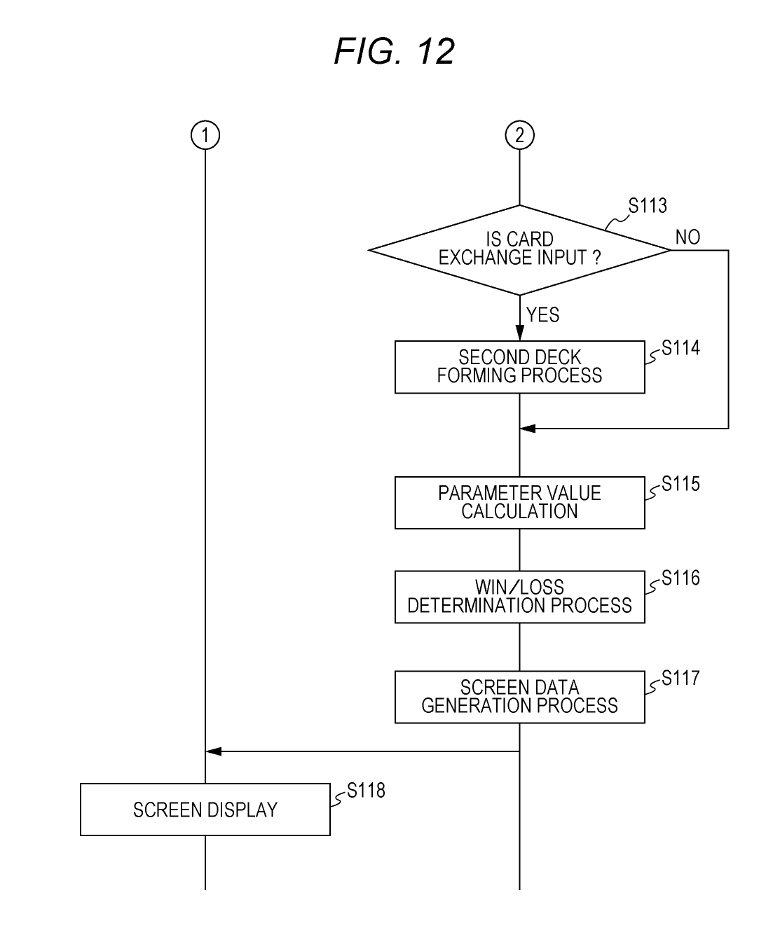

FIGS. 11 and 12 are flowcharts for explaining an example of operation of the game system 1 according to the present embodiment.

As illustrated in FIG. 11, first, in a player terminal 20, upon receiving an operation input made by the player from the terminal input unit 23, the terminal control unit 21 transmits a command (opponent selection request) for acquiring a web page for selecting an opponent to the server device 10 via the terminal communication unit 25 (S101).

Subsequently, upon receiving the opponent selection request transmitted from the player terminal 20, the server device 10 causes the screen data generation unit 118 to generate screen data (HTML data) for displaying an opponent selection screen 50 (see FIG. 13 (1)), which will be described later, on the player terminal 20 (S102). The server device 10 then transmits the screen data (HTML data) generated by the screen data generation unit 118 to the requesting player terminal 20 via the communication unit 15.

Subsequently, upon receiving the screen data (HTML data) transmitted from the server device 10, the player terminal 20 analyzes the screen data to display a game screen corresponding to the screen data on the terminal display unit 24 (S103).

FIG. 13 (1) is a diagram illustrating an example of the opponent selection screen 50 displayed on the terminal display unit 24. The opponent selection screen 50 is a game screen for selecting an opponent and includes check boxes 51 for specifying an opponent from a list and an operation button 52 for starting a battle. The player terminal 20 receives operation inputs relating to selection of an opponent and starting a battle from the player while the opponent selection screen 50 is displayed on the terminal display unit 24 (S104). It is assumed here that a “player X” is specified as the opponent for the player as a result of selection of a check box 51 and that a battle is then started as a result of selection of the operation button 52. Thereafter, the player terminal 20 transmits a battle start request in which the operation information is set to the server device 10 (S105). Upon receiving the request, the server device 10 starts a battle game with the opponent specified by the player. In the present embodiment, the battle processing unit 117 performs a battle game process for a poker game to determine the outcome.

In the battle game process for the poker game, the server device 10 first causes the first deck forming unit 114A to execute a first deck forming process (S106). The first deck forming unit 114A refers to the player information illustrated in FIG. 5 and the possessed card information illustrated in FIG. 6 to select a plurality of game cards from the cards possessed by the player and a plurality of game cards from the cards possessed by the opponent. In the present embodiment, since each possessed card has any one of the four suit attributes of spade, heart, club, and diamond, six possessed cards are selected for each suit attribute. In this process, the first deck forming unit 114A automatically selects six possessed cards on the basis of a card parameter value set for each possessed card. Specifically, the first deck forming unit 114A refers to the card information illustrated in FIG. 4 and the possessed card information illustrated in FIG. 6 and selects six possessed cards in descending order of the attack point parameter value for each suit attribute. Alternatively, the first deck forming unit 114A may select possessed cards specified by the player in response to operation input from the player instead of automatic selection mentioned above. The first deck forming unit 114A then assigns any one of six number attributes of 9, 10, 11 (jack: J), 12 (queen: Q), 13 (king: K), and 1 (ace: A) to each of the six selected possessed cards of each suit attribute. The first deck forming unit 114A then forms a preliminary deck composed of 24 game cards in combination of four suit attributes and six number attributes put into a set for each of the player and the opponent. After the preliminary decks are formed in this manner, the first deck information illustrated in FIG. 7 is stored in the data storage unit 12 of the server device 10.

Subsequently, the server device 10 causes the second deck forming unit 114B to execute a second deck forming process (S107). The second deck forming unit 114B refers to the player information illustrated in FIG. 5 and the first deck information illustrated in FIG. 7 to select a plurality of game cards from the preliminary deck of the player and a plurality of game cards from the preliminary deck of the opponent. In the present embodiment, five game cards are randomly selected from the 24 game cards included in the preliminary deck. The second deck forming unit 114B then associates the five selected game cards with unit areas, respectively, constituting a card placement area. The second deck forming unit 114B then forms a battle deck of five game cards put into a set for each of the player and the opponent. After the battle decks are formed in this manner, the second deck information illustrated in FIG. 8 is stored in the storage unit 12 of the server device 10.

Subsequently, the server device 10 performs a process of calculating deck parameter values set for the battle decks formed in this manner (S108). Hereinafter, the calculation process will be described more specifically.

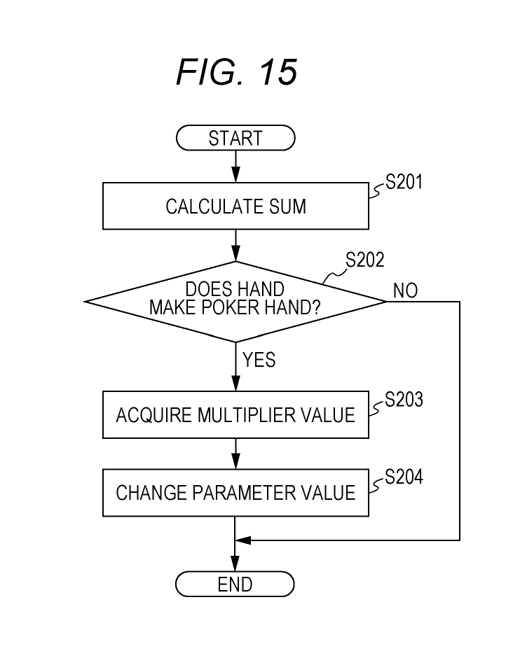

FIG. 15 is a flowchart for explaining the process for calculating the deck parameters set for the battle decks.

First, the parameter determining unit 115 refers to the player information illustrated in FIG. 5, the possessed card information illustrated in FIG. 6, and the second deck information illustrated in FIG. 8 to acquire the card parameter value of each of the game cards included in the battle deck of the player (here, the attack point parameter value is acquired), and calculates the sum of all the card parameter values (S201). Similarly for the battle deck of the opponent, the parameter determining unit 115 calculates the sum of all the card parameter values. The parameter determining unit 115 then determines the sum of card parameter values thus calculated to be the deck parameter value set for the battle deck.

Alternatively, in step S201, the deck parameter value set for the battle deck may be determined by acquiring the card parameter value of each of the game cards (24 game cards) included in the preliminary deck, calculating the sum of all of the card parameter values, and determining the sum to be the deck parameter value set for the battle deck.

Subsequently, the determination unit 112 determines whether or not the parameter change condition is satisfied, that is, whether or not each of the battle decks of the player and the opponent makes a preset poker hand (S202).

If a poker hand is not made (S202: NO), this process is terminated. If, on the other hand, a poker hand is made (S202: YES), the parameter changing unit 116 refers to the card hand information illustrated in FIG. 9 to acquire the multiplier value associated with the poker hand (S203).

Subsequently, the parameter changing unit 116 changes the deck parameter value determined by the parameter determining unit 115 (S204). For example, if a poker hand “one pair” is made by the battle deck when the deck parameter value is “10000”, the multiplier value is “1.1” (see FIG. 9), and thus the deck parameter value is changed to 11000.

Alternatively, in step S204, an added value may be used instead of a multiplier value mentioned above for changing the deck parameter value determined by the parameter determining unit 115. Still alternatively, while the deck parameter value of the player is changed by using a multiplier value (or an added value), the deck parameter value of the opponent may be changed by using a divisor value (or a subtrahend value).

Referring back to FIG. 11, upon calculation of the deck parameter values set for the battle decks in the battle game process of the poker game in this manner, the server device 10 transmits the screen data (HTML data) generated by the screen data generation unit 118 to the requesting player terminal 20 via the communication unit 15 (S109).

Subsequently, the player terminal 20 analyzes the screen data (HTML data) transmitted from the server device 10 to display a game screen corresponding to the screen data on the terminal display unit 24 (S110).

FIG. 13 (2) is a diagram illustrating an example of a battle screen 60 displayed on the terminal display unit 24. The battle screen 60 is a game screen for conducting a battle between the battle deck of the player and the battle deck of the opponent, and includes a first card placement area 61, a first poker hand display area 62, a first deck parameter display area 63, a second card placement area 64, a second poker hand display area 65, a second deck parameter display area 66, a game advancement button 67, and a card exchange button 68. The first card placement area 61 is an area for placing the battle deck of the player, in which the game cards included in the battle deck are placed in five unit areas 61A to 61E, respectively. The first poker hand display area 62 is an area for displaying a poker hand made by the battle deck of the player. The first deck parameter display area 63 is an area in which parameter information indicating the deck parameter value set for the battle deck of the player is displayed. The second card placement area 64 is an area for placing the battle deck of the opponent, in which the game cards included in the battle deck are placed in five unit areas 64A to 64E, respectively. The second poker hand display area 65 is an area for displaying a poker hand made by the battle deck of the opponent. The second deck parameter display area 66 is an area in which parameter information indicating the deck parameter value set for the battle deck of the opponent is displayed. The game advancement button 67 is an operation button for advancing the battle game. The card exchange button 68 is an operation button for replacing a game card in the battle deck of the player.

In the present embodiment, since “one pair” is made by the battle deck of the player as illustrated in FIG. 13 (2), a deck parameter value resulting from the change by the parameter changing unit 116 (a value obtained by multiplying the sum of card parameters by “1.1”; see FIG. 9) is displayed as “24500” in the first deck parameter display area 63. In the meantime, it is also apparent that “one pair” is also made by the battle deck of the opponent, but since part of the game cards (the game card placed in the unit area 64E) is hidden on the display, there is a possibility that “two card” or “three of a kind” is made by the battle deck of the opponent. In addition, a deck parameter value resulting from the change by the parameter changing unit 116 (a value obtained by multiplying the sum of card parameters by the multiplier value; see FIG. 9) is displayed as “25000” in the second deck parameter display area 66. The player sees the battle screen 60 and finds out that there is a possibility of losing in this state since the deck parameter value (“24500”) of the player is smaller than the deck parameter value (“25000”) of the opponent. There is, however, a possibility that the player will come from behind and win by exercising a skill on the battle deck of the player even if the battle game is advanced in this state (exercise of a skill will be described in detail later). Alternatively, there is a possibility that the difference between the deck parameters will become larger and totally lose if “two pair” or “three of a kind” is made by the battle deck of the opponent. The player can thus select the game advancement button 67 or the card exchange button 68 taking these possibilities into account.

Here, a case in which the card exchange button 68 is selected by the player will be described. FIG. 13 (3) is a diagram illustrating a state in which a card to be replaced is selected on the battle screen 60 displayed on the terminal display unit 24. When the player selects unit areas in which game cards to be replaced are placed (herein, three game cards placed in the unit areas 61C to 61E are selected as cards to be replaced) in the first card placement area 61, the indications of “HOLD” for the game cards to be replaced disappear and the game cards to be replaced are emphasized as illustrated in FIG. 13 (3). Thereafter, when the player selects the card exchange button 68, a process for exchanging game cards is executed.

As described above, the player terminal 20 receives an operation input relating to advancement of the battle game (an input of selection of the game advancement button 67, an input of selection of the card exchange button 68, or the like) from the payer while the battle screen 60 is displayed on the terminal display unit 24 (S111). Thereafter, the player terminal 20 transmits a battle advancement request in which the operation information is set to the server device 10 (S112).

Subsequently, upon receiving the request, the server device 10 continues the battle game process for the poker game. As illustrated in FIG. 12, the server device 10 causes the determination unit 112 to execute a process of determining whether an operation input selected by the player is the input of selection of the game advancement button 67 or the input of selection of the card exchange button 68 on the basis of the received operation information (S113). If it is determined that the operation input by the player is the input of selection of the game advancement button 67 (S113: NO), the process proceeds to step S115. If, on the other hand, it is determined that the operation input by the player is the input of selection of the card exchange button 68 (S113: YES), the second deck forming unit 114B executes the second deck forming process (S114). The second deck forming unit 114B refers to the player information illustrated in FIG. 5 and the first deck information illustrated in FIG. 7 to select the number of game cards corresponding to the number of game cards to be replaced from the preliminary deck of the player. In the present embodiment, since three game cards are to be replaced (see FIG. 13 (3)), three game cards are randomly selected from 19 game cards in the preliminary deck (since five cards are already selected, not 24 but 19 game cards are candidates for selection in the preliminary deck). The second deck forming unit 114B then associates the three selected game cards with the unit areas 61C to 61E, respectively, in the card placement area 61. The second deck forming unit 114B then forms a new battle deck of five game cards put into a set. After the battle deck is formed again in this manner, the second deck information illustrated in FIG. 8 is updated and stored in the data storage unit 12 of the server device 10.

Subsequently, the server device 10 performs a process of recalculating deck parameter values set for the battle decks of the player and the opponent (S115). Hereinafter, the calculation process will be described more specifically.

First, the process of calculating the deck parameters to be set for the battle decks illustrated in FIG. 15 is executed again to calculate the deck parameter value determined by the parameter determining unit 115 or the deck parameter value resulting from the change by the parameter changing unit 116 for each of the battle decks of the player and the opponent.

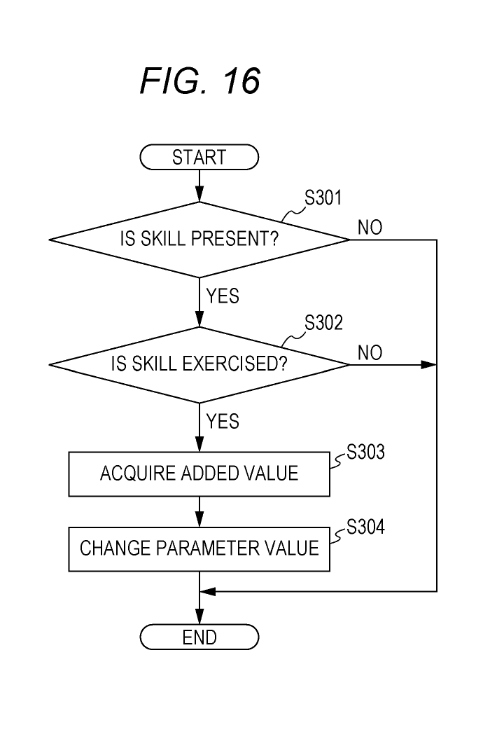

Next, a process of calculating deck parameters to be set for the battle decks illustrated in FIG. 16 is executed. Here, the determination unit 112 first refers to the possessed card information illustrated in FIG. 6 and the second deck information illustrated in FIG. 8 to determine whether or not the game cards included in the battle deck of the player have a skill (S301). The determination is made similarly on the battle deck of the opponent.

If it is determined that the battle deck does not have a skill (S301: NO), this process is terminated. If, on the other hand, it is determined that the battle deck has a skill (S301: YES), the process proceeds to step S302.

Subsequently, the determination unit 112 determines whether or not the parameter change condition is satisfied, that is, whether or not the skill is to be exercised on each of the battle decks of the player and the opponent on the basis of a predetermined probability (S302).

If it is determined not to exercise the skill (S302: NO), this process is terminated. If, on the other hand, it is determined to exercise the skill (S302: YES), the parameter changing unit 116 refers to the skill information illustrated in FIG. 10 to acquire the added value associated with the skill to be exercised (S303).

Subsequently, the parameter changing unit 116 changes the deck parameter value determined by the parameter determining unit 115 (the value calculated by executing the deck parameter calculation process illustrated in FIG. 15) or the deck parameter value resulting from the change by the parameter changing unit 116 (the value calculated by executing the deck parameter calculation process illustrated in FIG. 15) by using the acquired added value (S304). For example, if a skill “A” is exercised on the battle deck when the deck parameter value (the value calculated by executing the deck parameter calculation process illustrated in FIG. 15) is “11000”, the added value is “500” (see FIG. 10) and thus the deck parameter value changes to “11500”.

Alternatively, in step S304, a multiplier value may be used instead of an added value mentioned above for changing the deck parameter value determined by the parameter determining unit 115. Still alternatively, while the deck parameter value of the player is changed by using an added value (or a multiplier value), the deck parameter value of the opponent may be changed by using a subtrahend value (or a divisor value).

Alternatively, in step S115 described above, the calculation process using a multiplier value illustrated in FIG. 15 may be executed after the calculation process using an added value illustrated in FIG. 16 is executed. For example, the card parameter values of the game cards are changed by using the added value associated with the exercised skill, and the sum of the card parameter values resulting from the change is set as the deck parameter value. Thereafter, the deck parameter value is changed by using the multiplier value associated with the poker hand that is made.

Referring back to FIG. 12, after the deck parameter values set for the battle decks of the player and the opponent are calculated again in this manner, the server device 10 causes the battle processing unit 117 to execute a win/loss determination process of determining the outcome of the battle game (S116). Specifically, the battle processing unit 117 determines the outcome of the battle game by using the deck parameter value determined by the parameter determining unit 115 (the value calculated by executing the deck parameter calculation process illustrated in FIG. 16) or the deck parameter value resulting from the change by the parameter changing unit 116 (the value calculated by executing the deck parameter calculation process illustrated in FIG. 16). More specifically, the battle processing unit 117 compares the deck parameter value set for the battle deck of the player and the deck parameter value set for the battle deck of the opponent, and determines one having the larger deck parameter value to be the winner and the other having the smaller deck parameter value to be the loser.

Note that the battle processing unit 117 changes the card parameter values (such as attack point) of the game cards included in the battle deck according to the win/loss result. As a result, the combination of game cards included in the preliminary decks for a next battle can be changed each time a battle is performed. Specifically, the kinds of game cards to be candidates for selection can be changed in formation of battle decks.

Subsequently, after the outcome is determined by the battle game process for the poker game in this manner, the server device 10 transmits screen data (HTML data) generated by the screen data generation unit 118 to the requesting player terminal 20 via the communication unit 15 (S117).

Subsequently, the player terminal 20 analyzes the screen data (HTML data) transmitted from the server device 10 to display a game screen corresponding to the screen data on the terminal display unit 24 (S118).

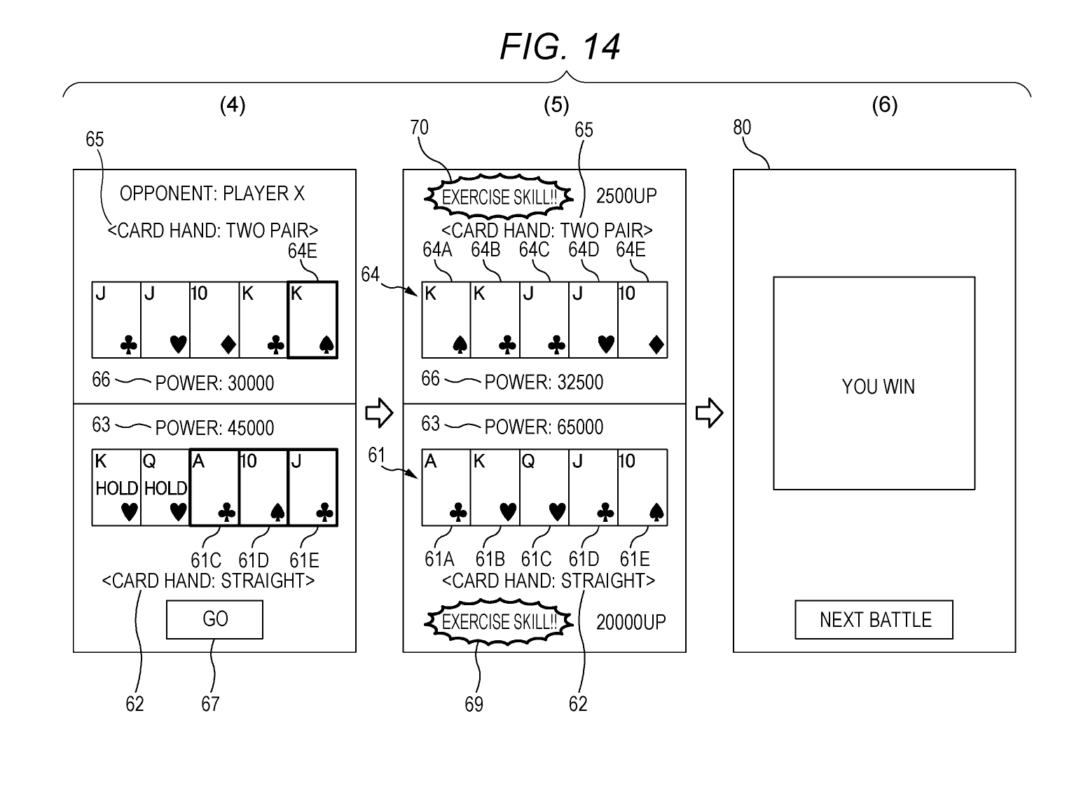

FIG. 14 (4) is a diagram illustrating a state after card exchange of the battle screen 60 displayed on the terminal display unit 24. In the battle screen 60, since three game cards placed in the unit areas 61C to 61E are selected to be replaced on the battle screen 60 illustrated in FIG. 13 (3), the game cards resulting from the exchange are newly placed on the unit areas 61C to 61E as illustrated in FIG. 14 (4). Furthermore, in the battle screen 60, the game card placed in the unit area 64E but hidden on the display on the battle screen 60 illustrated in FIG. 13 (3) is revealed.

In the present embodiment, since “straight” is newly made by the battle deck of the player as illustrated in FIG. 14 (4), a deck parameter value resulting from the change by the parameter changing unit 116 (a value obtained by multiplying the deck parameter before the change by “1.4”; see FIG. 9) is displayed as “45000” in the first deck parameter display area 63. In the meantime, since “two pair” is made by the battle deck of the opponent, a deck parameter value resulting from the change by the parameter changing unit 116 (a value obtained by multiplying the deck parameter before the change by “1.2”; see FIG. 9) is displayed as “30000” in the second deck parameter display area 66. When the game advancement button 67 is then selected by the player, the screen changes to the battle screen 60 illustrated in FIG. 14 (5).

FIG. 14 (5) is a diagram illustrating a state in which a skill is exercised on the battle screen 60 displayed on the terminal display unit 24. The battle screen 60 includes skill exercise display areas 69 and 70 indicating a skill being exercised on the battle decks. In the present embodiment, “20000” is added to the deck parameter as a result of exercise of the skill on the battle deck of the player, and the deck parameter value resulting from the change by the parameter changing unit 116 is displayed as “65000” in the first deck parameter display area 63. In the meantime, “2500” is added to the deck parameter as a result of exercise of the skill on the battle deck of the opponent, and the deck parameter value resulting from the change by the parameter changing unit 116 is displayed as “32500” in the second deck parameter display area 66. The player then sees the battle screen 60 and finds out that the player can win the battle game since the deck parameter value (“65000”) of the player is larger than the deck parameter value (“32500”) of the opponent. Thereafter, the screen changes to a win/loss determination screen 80 illustrated in FIG. 14 (6) and the win/loss result is presented to the player.

As described above, according to the game system 1 according to the present embodiment, a battle of the poker game is conducted between the battle deck of the player and the battle deck of the opponent, and the calculated deck parameter values of the battle decks are compared to determine the outcome of the battle game. Upon determination of the outcome of the battle game, parameter information (for example, information displayed in the deck parameter display areas on the battle screen 60) indicating the deck parameter values at the outcome determination as well as the win/loss result are displayed to the player. Thus, player can know why the player won (or lost) and can thus accept the win/loss result of the battle game.

### Other Embodiments

The above-described embodiment has been given for easy understanding of the present invention, and is not to construe the present invention in a limited manner. The present invention can be modified and improved without departing from the gist of the invention and includes its equivalents. In particular, embodiments described below are also included in the present invention.

### <Formation of Battle Deck>

In the above-described embodiment, an example in which the second deck forming unit 114B randomly selects game cards at a given probability from a preliminary deck for forming a battle deck is described, the present invention is not limited thereto. For example, the probability for selection may be changed depending on the kind of the number attribute set for a game card. Specifically, the probability may be set so that game cards having any of three number attributes of 12 (queen: Q), 13 (king: K), and 1 (ace: A) are less likely to be selected than the other three number attributes among the six number attributes of 9, 10, 11 (jack: J), 12 (queen: Q), 13 (king: K), and 1 (ace: A).

Furthermore, in the above-described embodiment, an example in which the deck forming unit 114 first forms battle decks, the parameter determining unit 115 then determines the deck parameter values (and the parameter changing unit 116 changes the determined deck parameter values if the determination unit 112 determines that the parameter change condition is satisfied), and the battle processing unit 117 compares the deck parameter values to determine the outcome of the battle game is described, but the present invention is not limited thereto. For example, the battle processing unit 117 may first determine the outcome, and thereafter, the parameter determining unit 115 may determine the deck parameter value of the battle decks according to the outcome determined by the battle processing unit 117, and the deck forming unit 114 may form the battle decks to meet the determined deck parameter values. Specifically, the deck forming unit 114 may select game cards so that the determined deck parameter value and the sum of card parameters agrees with each other. Alternatively, the deck forming unit 114 may select game cards so that the determined deck parameter value and the value resulting from changing the sum of card parameters agree with each other (so that the parameter change condition is satisfied by the battle deck (for example, a predetermined hand is made)).

### <Battle Game>

In the above-described embodiment, an example of the poker game is described as an example of the battle game, the present invention is not limited thereto and the battle game may be other card games, mah-jong, Hanafuda (Japanese playing cards) or the like.

### <Server Device>

In the above-described present embodiments, the game system 1 provided with one server device 10 as an example of a server device has been exemplarily described. However, the game system 1 is not limited to this example, and may be provided with a plurality of server devices 10 as an example of the server device. Specifically, a plurality of server devices 10 may be connected through a network 2, and each of the server devices 10 may perform various types of processing in a distributed manner.

### <Information Processing Device>

In the above-described game system 1 in the present embodiments, an example in which various types of information processing are executed on the basis of a game program by the server device 10 and the player terminal 20 in cooperation with each other is described. However, the game system 1 is not limited to the example. The various types of information processing may be executed by the player terminal 20 alone or by the server device 10 alone as an information processing device on the basis of a game program.

Furthermore, the player terminal 20 may bare some of the functions of the information processing device. In this case, the server device 10 and the player terminal 20 constitute the information processing device.

Note that the information processing device is an example of a computer provided with a processor and a memory.

What is claimed is:

1. An information processing device that conducts a battle game played by a player by using a battle deck composed of a plurality of game contents, the information processing device comprising:
a deck forming unit configured to form the battle deck to be used for a battle by the player;
a parameter determining unit configured to determine a deck parameter value set for the battle deck formed by the deck forming unit on the basis of game content parameter values set for the game contents included in the battle deck;
a storage unit configured to store a parameter change condition that is a condition for changing the deck parameter value determined by the parameter determining unit and a predetermined value by which the deck parameter value determined by the parameter determining unit is changed in association with each other;
a determination unit configured to determine whether or not the parameter change condition is satisfied after the deck parameter value is determined by the parameter determining unit;
a parameter changing unit configured to change the deck parameter value determined by the parameter determining unit by using a predetermined value corresponding to the parameter change condition when the parameter change condition is determined to be satisfied by the determination unit;
a battle processing unit configured to:
determine an outcome of a battle game by using the deck parameter value resulting from the change by the parameter changing unit when the parameter change condition is determined to be satisfied by the determination unit, and
determine an outcome of a battle game by using the deck parameter value determined by the parameter determining unit when the parameter change condition is determined not to be satisfied by the determination unit; and
a screen data generation unit configured to generate data of a game screen on which parameter information indicating the deck parameter value resulting from the change by the parameter changing unit or the deck parameter value determined by the parameter determining unit after an outcome is determined by the battle processing unit,
wherein the storage unit is configured to store a game content for which any of multiple kinds of first attributes is set and a player possessing the game content in association with each other, and
wherein the deck forming unit includes a first deck forming unit configured to select a plurality of game contents from game contents possessed by the player for each of the first attributes, and assign any of a plurality of kinds of second attributes to each of the selected game content to form a preliminary deck composed of game contents each having the first attribute and the second attribute, and a second deck forming unit configured to randomly select game contents each having the first attribute and the second attribute from the preliminary deck to form a battle deck.

2. The information processing device according to claim 1,
wherein the first deck forming unit select game contents included in the preliminary deck from game contents possessed by the player in response to operation input by the player.

3. The information processing device according to claim 1, wherein
the first deck forming unit selects a plurality of game contents included in the preliminary deck from game contents possessed by the player on the basis of game content parameters set for the respective game contents.

4. A non-transitory computer-readable storage medium storing a game program causing a computer that is an information processing device, which conducts a battle game played by a player using a battle deck composed of a plurality of game contents, to execute:
a deck forming process of forming the battle deck to be used for a battle by the player;
a parameter determination process of determining a deck parameter value set for the battle deck formed by the deck forming process on the basis of game content parameter values set for the game contents included in the battle deck;
a storage process of storing a parameter change condition that is a condition for changing the deck parameter value determined by the parameter determination process and a predetermined value by which the deck parameter value determined by the parameter determination process is changed in association with each other;
a determination process of determining whether or not the parameter change condition is satisfied after the deck parameter value is determined by the parameter determination process;
a parameter changing process of changing the deck parameter value determined by the parameter determining unit by using a predetermined value corresponding to the parameter change condition when the parameter change condition is determined to be satisfied by the determination process;
a battle process of:
determining an outcome of a battle game by using the deck parameter value resulting from the change by the parameter changing process when the parameter change condition is determined to be satisfied by the determination process, and
determining an outcome of a battle game by using the deck parameter value determined by the parameter determination process when the parameter change condition is determined not to be satisfied by the determination process; and
a screen data generation process of generating data of a game screen on which parameter information indicating the deck parameter value resulting from the change by the parameter changing process or the deck parameter value determined by the parameter determination process after an outcome is determined by the battle process
wherein the storage process includes storing a game content for which any of multiple kinds of first attributes is set and a player possessing the game content in association with each other, and
wherein the deck forming process includes a first deck forming process of selecting a plurality of game contents from game contents possessed by the player for each of the first attributes, and assigning any of a plurality of kinds of second attributes to each of the selected game content to form a preliminary deck composed of game contents each having the first attribute and the second attribute, and a second deck forming process of randomly selecting game contents each having the first attribute and the second attribute from the preliminary deck to form a battle deck.
